(19) United States
(12) Patent Application Publication
(10) Pub. No.: US 2007/0102480 A1
(43) Pub. Date: May 10, 2007

(54) Welded connections

(76) Inventor: Teh Lip, Marrickville (AU)

Correspondence Address: BROMBERG & SUNSTEIN LLP, 125 SUMMER STREET, BOSTON, MA, 02110-1618, US

(21) Appl. No.: 10/552,180

(22) PCT Filed: Apr. 8, 2004
(86) PCT No.: PCT/AU04/00463

§ 371 Date: Oct. 5, 2005

(30) Foreign Application Priority Data
Apr. 8, 2003 (AU) 2003901595

(51) Int. Cl. A47J 36/02

(52) U.S. Cl. 228/101

(57) ABSTRACT

A method for welding an end of a polygonal hollow section (PHS) to a member comprises the step of forming a weld across a surface of the PHS. The weld extends continuously from a connection weld connecting the PHS and the member to a location remote from the connection weld. The surface of the PHS is typically one or more flanges of the PHS, and the PHS is typically an RHS or SHS, such that the surface can be part of just one flange. A method for increasing the rotation capacity in a welded moment connection between a PHS and a member is also defined. The method comprises the step of forming a weld between the PHS and the member in a manner such that strain in corner(s) of the PHS, located at an end of the PHS that is weld connected to the member, is redistributed to an adjacent flange of the PHS. Alternatively the method may comprise the step of forming a weld between the PHS and the member in a manner that minimises the extent to which a heat effected zone through a flange of the PHS lies in a fracture zone adjacent to an internal end of the weld.

### FIELD OF THE INVENTION

The present invention relates to a method for improving the welded connection between a polygonal hollow section (hereinafter “PHS”) and another member. In a particular though not exclusive form, the present invention relates to a method for increasing the rotation capacity in a welded moment connection between a PHS and a member.

### BACKGROUND TO THE INVENTION

In the cold-forming of metal polygonal hollow sections (PHS), and in particular rectangular and square hollow sections (RHS and SHS), the ductility of the metal (typically steel) is reduced. A reduction in metal ductility reduces the metal's plastic capacity, thereby increasing the likelihood of metal fracture in highly tensioned regions that can result from excess loading of the PHS. When the PHS is used in structural applications, unexpected or uncontrolled metal fracture under load can have catastrophic consequences.

Cold-formed metal sections (especially hollow steel sections) are widely used in building construction as secondary structural elements (such as purlins and girts), but are now used increasingly as primary structural elements, including as support posts, rafters, joists etc. There are certain advantages to the use of metal hollow sections, particularly RHS and SHS, as structural members in place of I-sections. These include a higher degree of torsional rigidity of RHS due to its closed profile, increased flange stiffening, and increased shape factor. High torsional rigidity can also eliminate or greatly reduce the need for lateral bracing, as RHS has reduced lateral-torsional instability compared to other flexural members, such as I-sections. Elimination of bracing reduces construction cost and simplifies construction procedures.

However, the reduced metal ductility of cold-formed sections, as compared to hot-rolled sections, can adversely affect structural performance during unusual or unexpected load situations, with an increased risk of catastrophic failure, especially where the hollow sections are used as primary structural elements in building construction.

One region where reduced ductility of cold-formed hollow sections can have a more pronounced negative influence on structural performance is at a welded joint between the hollow section and another member. This is especially so when a bending moment about the joint occurs under load. The other member may be another hollow section to which the first hollow section is welded end to end, or the first hollow section may be welded to the other hollow section intermediate to its ends to extend laterally therefrom. Alternatively, the other member may be a plate, for example a base plate of a post, a stiffening plate, a connecting plate, a top plate etc.

For example, where RHS is used as a primary construction element, so-called “knee” and “apex” joints can be formed between an RHS upright and an RHS rafter or between one RHS rafter and another RHS rafter. In this regard, FIG. 1 schematically depicts a known portal frame construction showing knee and apex joints between upright/rafter and rafter/rafter. At the knee and apex joints, the hollow sections may be welded directly together (as illustrated in FIG. 2b), or a stiffening plate may be welded between the two hollow sections (as shown in FIG. 2a) to provide for increased joint stiffness and increased strength at the weld.

In the design of steel frames, such as those illustrated in FIG. 1, two established design methods have been employed, namely, the elastic design method and the plastic design method. The plastic design method is increasingly employed for steel frames which resist their loads primarily by flexure and which fail through a plastic collapse mechanism once a sufficient number of plastic hinges have formed in the frame.

However, only recently has the plastic design method been applied to steel frames formed from cold-formed rectangular hollow section. A key requirement for the plastic design of a steel frame is the ability of the members in which the first plastic hinges form to sustain localised rotations, so that any additional bending moments can be redistributed to other members which then form a sufficient number of plastic hinges for the plastic collapse mechanism to occur. By “sustain”, it is meant that the bending moment at the plastic hinge must not fall below the plastic moment during the hinge rotation. A design based on a plastic collapse mechanism can provide a controlled as opposed to catastrophic failure of the structure in which the hollow sections are employed.

Recent tests by Wilkinson (1999) “The plastic behaviour of cold-formed rectangular hollow sections”, PhD Thesis, Department of Civil Engineering, University of Sydney, Australia, have shown that a plastic collapse mechanism can form in a gable frame even though RHS members of that frame do not satisfy the material requirements specified for plastic design in the Australian Steel Structures Standard AS4100:1998.

Thus the plastic design method, one criteria that is desirably enhanced is the rotation capacity of a metal section under bending moments. A greater rotation capacity allows the plastic hinge in the member to continue rotating while bending moments are redistributed to other parts of the structure under increasing loads. The suitability of a steel section for use in the plastic design of frames is typically assessed by its rotation capacity. Since the rotation of a “plastic hinge” is related to the change in the maximum curvature of the plastic zone over time, the rotation capacity R of a structural section is typically defined as:
R=K₁/Kₚ−1 (1)
in which K₁ is the curvature at which the bending moment at the plastic hinge drops below the plastic moment Mₚ, and Kₚ is the curvature at which the plastic moment is first reached. Rotation capacity is illustrated in FIG. 3, where the normalised bending moment M/Mₚ is plotted against the normalised curvature K₁/Kₚ. A number of international structural standards specify a rotation capacity R of at least 3.

Wilkinson and Hancock (1998) “Tests to examine compact web slenderness of cold-formed RHS” Journal Of Structural Engineering, ASCE, 124 (10), 1166-1174 have shown that the commercial product DuraGal C450 150×50×4 mm RHS does have a rotation capacity that is adequate for plastic design (DuraGal is a trade mark of OneSteel Trading Pty Ltd). However in separate experimentation Wilkinson & Hancock (2000) “Tests to examine plastic behaviour of knee joints in cold-formed RHS” Journal of Structural Engineering, ASCE, 126 (3), 297-305, internal sleeves had to be used at the welded knee joints of a frame to prevent premature fracture as a result of a bending moment at the knee joint. In this regard, FIG. 4 illustrates in three views the use of an internal sleeve in a knee joint.

The present inventors have adopted an alternative definition of rotation capacity (which is the definition employed in this specification) as follows:
R=(α₁−α₀)/(αₚ−α₀)−1 (2)
in which α₁ is the angle between the two members at which the bending moment at the plastic hinge drops below Mₚ, α₀ is the angle between the two members at the initial unloaded state, and αₚ is the angle between the two members when Mₚ is first reached. This equation thus defines that rotation capacity R=(normalised rotation at which the bending moment at the plastic hinge drops below Mₚ)−1. The definition is also schematically illustrated in FIG. 7. The variable α_{D} in FIG. 7 represents the angle α at an arbitrary state.

It is postulated that premature fracture at a knee or apex joint occurs partly because of longitudinal welding residual stresses that are oriented orthogonal to applied bending stresses under load. It is known that longitudinal welding residual stresses are close to the yield stress of a welded material, thereby restricting the plastic deformations under the applied stresses. It is also known that welding heat input causes a significant reduction in both the tensile strength and elongation at fracture of DuraGal C450 RHS at the welded knee joint.

Wilkinson and Hancock (ibid) disclose the use of an internal sleeve at a knee joint to support the RHS at the weld. However, the use of an internal sleeve at each knee joint in a frame adds significant expense and complexity to the construction of steel frames, and it would be advantageous if the use of this or other reinforcement elements could be avoided.

### SUMMARY OF THE INVENTION

In a first aspect the present invention provides a method for welding an end of a polygonal hollow section (PHS) to a member comprising the step of forming a weld across a surface of the PHS, the weld extending continuously from a connection weld connecting the PHS and the member to a location remote from the connection weld.

Typically the surface of the PHS is one or more flanges of the PHS. In the case of an RHS or SHS subject to monotonic loading, the surface is typically part of just one flange. For other PHS the surface may be part of two or more flanges. In this regard, the continuous weld is typically applied to the tensile flange or flanges of the PHS (being those flange(s) that are usually put into tension when a load is applied to cause a bending moment about the PHS/member joint).

For example, in structural frames employing a number of welded RHS members, usually the internally facing flange in the RHS at a knee joint, and the externally facing flange in an apex joint, define the tensile flanges for uplift loads applied to the frame (eg. from wind action). For downward loads (eg. snow etc on a roof) usually the internally facing flange at the apex joint, and the externally facing flange in the knee joint, define the tensile flanges. In either case, such loads cause a bending moment about the knee and apex joints.

The present inventors have surprisingly discovered that by forming a continuous weld extending across a surface, away from the usual connection weld at the end of the PHS, the use of internal sleeves or other reinforcement can be eliminated in knee and apex joints and other moment connections.

Preferably the step of forming a continuous weld comprises the steps of:
applying the connection weld across an edge of a flange of the PHS at the end thereof to connect the PHS to the member;
applying a weld bead across the flange that is spaced from the connection weld;
applying one or more intermediate weld beads to the flange so as to define the continuous weld between the connection and spaced weld beads.

Preferably the connection weld is applied as one or more beads (eg. in multiple passes) to at least those flanges (and parts of flanges) in tension under load. Typically, however, the connection weld is applied right around an end of the PHS to be joined to the member.

In the case of RHS and SHS members subject to monotonic loading, typically one flange defines the tensile flange such that the weld beads are applied only across that flange, typically transversely thereacross. However, in the case of other polygonal hollow sections (for example, triangular, pentagonal, hexagonal, octagonal hollow section etc.) the weld beads may need to be applied across two or more flanges thereof depending on the application in which the PHS is to be employed. Other PHS may require similar or different weld application methods. For example, the PHS may be formed by welding together two elongate C-sections, which when combined effectively define an RHS or SHS. Appropriate welds can then be applied to this PHS.

The term “flange” or “flanges” is a typical term used for the flat faces in a polygonal hollow section, especially RHS or SHS. In an RHS, it is common to refer to each of the opposing narrower faces as a flange, and to each of the opposing wider faces as a “web”, for example, when the section is bent about an axis parallel with the narrower faces. In this regard, reference is made to FIG. 5 which illustrates typical nomenclature used for two different types of RHS (with FIG. 5(a) showing an RHS with a seam weld formed in one of the flanges, and FIG. 5(b) showing a seam weld formed in one of the RHS corners). Thus, the terms “flange” and “flanges” are to be construed broadly and, in this regard, could also refer to the webs of an RHS, for example, where the RHS is bent about an axis parallel with the wider face (denoted the ‘web’ in FIG. 5(a)). The terms can also refer to the webs of an SHS or other PHS, and can even be used interchangeably with the terminology “face”.

Reference in this specification to the term “member” is a reference to any support in a structure to which the PHS is welded and can include another PHS, for example, where the respective PHS are welded end to end. Alternatively one end of the PHS can be welded to an intermediate location of the other PHS “member”. The term “member” also includes supporting plates, including stiffening plates, connecting plates, base and top plates etc. The term “member” may also refer to an upright (eg. a post), a rafter, a purlin, a girt or other structural element in a frame etc. In a typical application of the invention the PHS and the member define a joint about which a bending moment can be applied, usually as a result of a load applied to the PHS, or to the member, or both.

The sequence of applying each of the weld beads to define the continuous weld need not be in the order as outlined above for the first aspect. In accordance with the present invention, typically a so-called “bead deposit sequence” is performed in two different orders, namely, a so-called “forward” bead deposit sequence or a so-called “backward” bead deposit sequence. Usually, however, a connection weld is first applied across the edge of the flange of the PHS to connect the end of the PHS to the member although applying this weld first is not essential. In this regard, preferably the connection weld is applied as one or more bead passes right around the peripheral end of the PHS to fully connect that end to the member.

Once the connection weld has been applied, then either the forward or backward welding technique can be employed. In the forward bead deposit technique one or more successive intermediate weld beads are applied to the flange starting adjacent to the connection weld bead, to then progressively define the continuous weld, with the final weld bead then constituting the spaced weld bead. In the backward bead deposit technique, typically after applying the connection weld, the spaced weld bead is applied (also referred to hereafter as a “buffer” weld bead), and one or more successive intermediate weld beads are then applied, starting from adjacent to the spaced weld bead and progressing until the connection weld bead is reached, thereby defining the continuous weld. Whilst other permutations are possible (eg. the application of intermediate weld beads may be alternated to that of the forward and backward bead deposit sequences), the forward and backward techniques are the preferred techniques employed, with the backward technique being the most preferred.

The backward bead deposit sequence is typically employed as it has been surprisingly discovered that the formation and location of a heat-affected zone is significantly less detrimental when the backward technique is used, although advantageous results can still be achieved with the forward bead deposit sequence.

In a most preferred application of the present invention, when used to connect an RHS or SHS either to another RHS/SHS, to a plate or to an upright, and typically after forming a connection weld between the RHS/SHS and that member, the spaced weld bead is applied, and then two or more intermediate weld beads are applied between the spaced weld bead and the connection weld, typically in succession, starting with the first intermediate weld bead adjacent to the spaced weld bead. However, it should be appreciated that the number of intermediate weld beads employed and also the dimension of each bead is typically influenced by the dimensions of the PHS.

In a further preferred variation, typically an additional weld bead is applied in a region defined between the member, the connection weld bead and that intermediate weld bead immediately adjacent to the connection weld bead. The additional weld bead typically constitutes and is hereafter also referred to as a “reinforcement” weld bead.

The present inventors have recognised through finite element analysis (and have verified experimentally), that in a welded moment connection between a PHS and a member (eg. in a welded knee or apex joint) strain is concentrated at end “corners” of the PHS, being those regions at the end of a PHS where the PHS is bent to close the hollow section. In this regard, reference is again made to FIG. 5 which illustrates the location of the corners in an RHS.

Accordingly, in a second aspect the present invention provides a method for increasing the rotation capacity R in a welded moment connection between a PHS and a member comprising the step of forming a weld between the PHS and the member in a manner such that strain in corner(s) of the PHS, located at an end of the PHS that is weld connected to the member, is redistributed to an adjacent flange of the PHS.

The present inventors have surprisingly discovered that a controlled welding technique can be used to redistribute corner strain to an adjacent flange (or flanges) of the PHS.

Typically with the welded moment connection of the second aspect, preferred welding methods according to the first aspect of the invention can be employed to redistribute strain, but other welding methodologies can be employed. For example, the application of a single weld bead adjacent to the connection weld and then the application of a reinforcement weld bead between the adjacent weld bead, member and connection weld bead can achieve some strain re-distribution with a consequent increase in rotation capacity R.

In the case of an RHS or SHS subject to monotonic loading, to redistribute strain preferably a weld bead deposit sequence is employed transversely across a single flange, typically being the tensile flange. In the case of other PHS, or RHS subject to cyclic (or reversing) loading (eg. in seismic applications), bead deposit sequences may need to be applied across more than one flange (eg. in cyclic or seismic applications, weld bead deposit sequences may need to be applied to opposing flanges). Also, depending on the geometry and the strain distribution in those PHS, or the application in which they are used (eg. unusual or uneven loading situations) the beads may not necessarily extend transversely across those flange(s).

The present inventors have further recognised that in a conventional welded connection, and especially in a moment connection such as a knee or apex joint, a fracture zone is defined at a so-called “toe” (or inset end) of the connection weld at corner(s) of the PHS that is/are subjected to tension. The PHS is likely to fracture at this zone when a bending moment is applied around the PHS/member joint.

The present inventors have also recognised that when welding to connect a PHS to a member, a heat-affected zone is defined through each face and corner adjacent to the weld as a result of heat transferred from the weld material. The heat affected zone includes a region of grain coarsening in the PHS, which leads to reduced ductility of the PHS in that zone with lowering of the yield stress and tensile strength of the material, meaning that the PHS is more likely to fracture in this zone. FIG. 8 illustrates schematically this increased grain coarsening adjacent to a weld bead.

The present inventors have further recognised in the conventional welding of an RHS to a member using a connection weld right around the peripheral end of the RHS, that the fracture zone and heat affected zone correspond (ie. they overlap or interfuse each other). Thus, application of the conventional welding technique to connect a PHS to a member predisposes the PHS to fracture adjacent to the connection weld.

Accordingly, in a third aspect the present invention provides a method for increasing the rotation capacity R in a welded moment connection between a PHS and a member comprising the step of forming a weld between the PHS and the member in a manner that minimises the extent to which a heat-affected zone through a flange of the PHS lies in a fracture zone adjacent to an internal end of the weld.

The present inventors have surprisingly discovered that it is possible to weld in a manner that minimises the extent to which the heat-affected zone lies in or overlaps with the fracture zone, at least to some extent. By welding in this manner, the strength and ductility of the flange in the fracture zone are maintained so that the yield stress and tensile strength of the PHS in the fracture zone do not decrease significantly.

The present inventors have surprisingly discovered that when the backward bead deposit sequence (and permutations thereof) according to the first aspect is employed, especially when welding an RHS or SHS to a member, the extent to which the heat affected zone lies in the fracture zone can be minimised. However, other welding techniques may also be used.

The method is typically applied to a PHS that is formed from steel having reduced elongation at fracture when compared to a corresponding hot-formed steel section. The steel is typically susceptible to fracture in a heat affected zone adjacent to where the PHS is joined to the member. Typically the steel is cold-formed.

The present invention also relates to a polygonal hollow section that has been welded to a member in accordance with a method as set forth in the first, second or third aspects.

### BRIEF DESCRIPTION OF THE DRAWINGS

Notwithstanding any other forms which may fall within the scope of the present invention, preferred forms of the invention will now be described, by way of example only, with reference to the accompanying drawings in which:

FIG. 1 shows a schematic end elevation of a frame formed from rectangular hollow section, and illustrating knee and apex joints to which the welding method according to the present invention can be applied;

FIG. 2 shows side elevation details of two different prior art welding techniques for joining RHS together in, for example, the knee joints of the frame of FIG. 1, with FIG. 2(a) showing the use of an intermediate stiffening plate;

FIG. 3 is a graph that plots the normalised bending moment of a structural steel section against normalised curvature to illustrate the concept of rotation capacity;

FIG. 4 shows three different views of the mounting of a prior art internal sleeve in a knee joint to provide additional support to the welded moment connection between two RHS, with detail A showing a side schematic view, and sections B-B and C-C being taken through detail A;

FIG. 5 shows end views of two related RHS, illustrating typical nomenclature used in describing an RHS, with FIG. 5(a) showing a seam weld located in a flange of the RHS and FIG. 5(b) showing a seam weld located in a corner of the RHS;

FIG. 6 illustrates schematically a rigid plastic collapse mechanism in sequence for a built-in beam with associated bending moment diagrams and curvature diagrams;

FIG. 7 illustrates schematically and sequentially the plastic rotations of a knee joint used in deriving the definition of rotation capacity that is employed in this specification (as given previously);

FIG. 8 depicts the effects of welding on the heat-affected zones adjacent to a weld bead;

FIG. 9 is a perspective view of a stiffened welded knee joint fabricated using a normal welding procedure and illustrating a typical corner fracture of an RHS;

FIG. 10 is an elevation of a to-be-welded stiffened knee joint and illustrating the positioning of spaced buffer welds on each RHS;

FIGS. 11 and 12 are a side view and elevation respectively of a stiffened knee joint illustrating additional layers of weld applied in accordance with a preferred welding method according to the present invention;

FIG. 13 is a graph that plots typical stress-strain curves for a 150×50×4 mm RHS, illustrating the performance of different regions as defined in FIG. 5 of the RHS under load;

FIG. 14 is a perspective representational view of a normally welded stiffened knee joint derived from a linear finite element analysis showing strain distribution under bending;

FIG. 15 is a similar view to FIG. 14 but where the finite element analysis including plasticity has been calculated at a maximum bending moment of 1.181 times the nominal plastic moment;

FIG. 16 is a similar view to FIG. 15 but where the stiffened knee joint has been provided with extra layers of weld in accordance with the present invention;

FIGS. 17, 19, 20, 22, 23 and 25-28 are graphs that plot normalised bending moment against normalised rotation to illustrate rotation capacity of prior art (ie. “Normal”) welded knee joint specimens and specimen embodiments according to the present invention;

FIG. 18 is an elevation of a stiffened knee joint welded in accordance with the present invention and illustrating the location of a fracture after a preferred testing procedure;

FIG. 21 is an elevation of a stiffened knee joint welded in accordance with the invention and illustrating the location of an additional reinforcement weld;

FIG. 24 is a side elevation of the stiffened knee joint welded in accordance with a “forward weld bead deposition sequence”;

FIG. 29 shows a composite micrograph of a section taken through a “forward” welded specimen in accordance with the invention;

FIG. 30 shows a composite micrograph through a section similar to FIG. 29 after being subjected to a fracture causing load;

FIG. 31 is a composite micrograph section through a “backward” welded specimen in accordance with the present invention;

FIG. 32 is a detail micrograph through a “backward” welded specimen at the weld “toe” and illustrating the heat affected zone (HAZ);

FIG. 33 is an enlarged detail micrograph taken from FIG. 32;

FIGS. 34(a) and (b) are side elevations of a stiffened welded knee (or apex) joint illustrating an optimal weld of width d formed using backward (a) or forward (b) weld bead deposit sequences in accordance with the present invention;

FIG. 35 is a schematic diagram of a knee joint specimen illustrating the forces causing bending moment applied during testing;

FIGS. 36 and 37 are plots of normalised rotation at fracture against weld layer width d (shown in FIG. 34), and illustrating the effect of this and other parameters on the ductility of DuraGal C450 150×50×4 mm and 150×50×4 mm RHS specimens respectively; and

FIG. 38 is a plot of rotation capacity R against the weld layer width d (shown in FIG. 34), and illustrating the effect of this and other parameters on the rotation capacities of 150×50×5 mm RHS specimens.

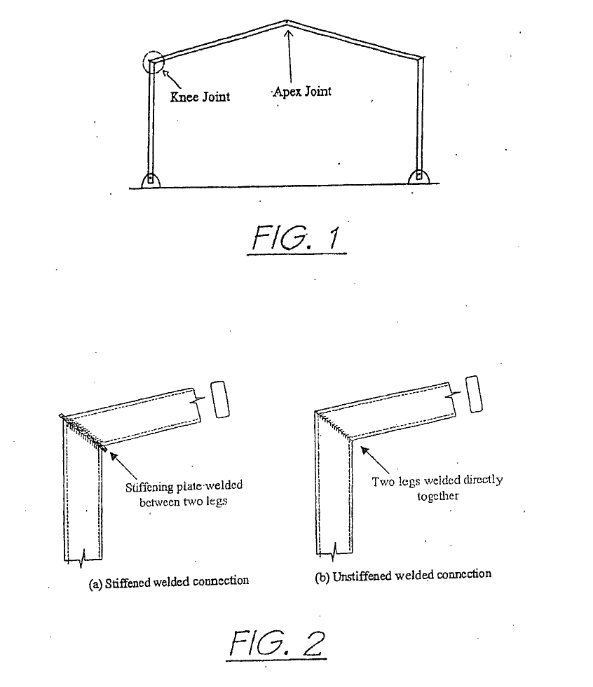

### MODES FOR CARRYING OUT THE INVENTION

In preferred forms, the invention was directed to welding-based methods that significantly increased the rotation capacity of a stiffened welded knee or apex joint between rectangular hollow sections (including square hollow sections) under opening moment, and is described hereinafter in this context. However, it should be appreciated that analogous methods can be employed for polygonal hollow sections (ie. other than rectangular and square hollow sections).

The preferred welding methods were found to be far more economical and expedient than the use of internal sleeves, and were able to be applied to new as well as existing structures (ie. retro-welding). Preferred techniques involved the deposition of extra layers (beads) of weld on the inner (tension) flange of a stiffened welded knee or apex joint. Laboratory test results were obtained to demonstrate that the preferred welding methods enabled a joint between DuraGal® C450 sections (DuraGal is a registered trade mark of OneSteel Ltd, Australia) of dimensions 150 mm×50 mm×4 mm or 150 mm×50 mm×5 mm RHS to satisfy the rotation capacity requirement specified for the plastic design of steel frames (specified by Hasan & Hancock 1988 “Plastic Bending Tests of Cold-Formed Rectangular Hollow Sections” Journal of the Australian Institute of Steel Construction, Vol. 23 No. 4, 2-19).

A number of factors that contributed to the lack of rotation capacity of a normally welded stiffened knee or apex joint were also identified. Increased rotation capacities following from the preferred welding methods were then analysed in terms of the effect of the extra layers of weld on the strain distribution around the knee and apex joints. Also shown through experimental tests and finite element analyses was that an important parameter of the proposed solution was the width of the extra layers of weld d (as shown in FIG. 34).

In addition, the presence of a seam weld in the RHS inner flange was observed to result in a reduced rotation capacity, however, the preferred welding methods still allowed for an adequate rotation capacity of a stiffened welded knee joint using DuraGal 150×50×5 RHS in this manner.

It was also noted that, in general, the extra layers of weld increased the rotation capacity R to an amount greater than the normalised rotation at which fracture occurred. This result was due to the less precipitous drop in the moment capacity of a connection that benefited from the invention, whether the forward or the backward welding technique was used, as evident from FIGS. 23, 25, and 27.

An appropriate definition for the rotation capacity of a knee (or apex) joint under opening moment was also proposed, and included the plastic moment to be used in measuring the rotation capacity.

Further background to the concept of rotation capacity will now be provided prior to describing preferred forms of the present invention in greater detail.

Rotation Capacity and Plastic Moment

A plastic hinge which can freely rotate under a constant bending moment and in which the curvature is infinite is only a theoretical assumption of the rigid plastic analysis method. This theoretical plastic hinge is actually a localised plastic zone where the curvatures are very high. Although in reality the material along a neutral axis of a simply supported beam will never yield, and there is no actual plastic hinge, the rigid plastic analysis method is able to predict the ultimate load capacity (based on excessive deformations due to the plastic collapse mechanism) of the simply supported beam with high accuracy. In fact, the rigid plastic analysis method is also able to predict the load at which a plastic collapse mechanism will form in a structure that has rotational restraints at the member ends, such as a built-in beam (ie. built into supports at opposing ends thereof) as depicted in FIG. 6.

As shown in FIG. 6, for the assumed plastic collapse mechanism to occur, the first plastic hinge at support A must be able to undergo a certain amount of rotation while maintaining the plastic moment Mₚ so that plastic hinges can also form at the loading point and the other support. As also shown in FIG. 6, the ultimate load Pᵤ of the built-in beam is a function of the plastic moment Mₚ. This is the fundamental of the plastic design method. The suitability of a steel section for use in the plastic design of frames is usually assessed by its rotational capacity.

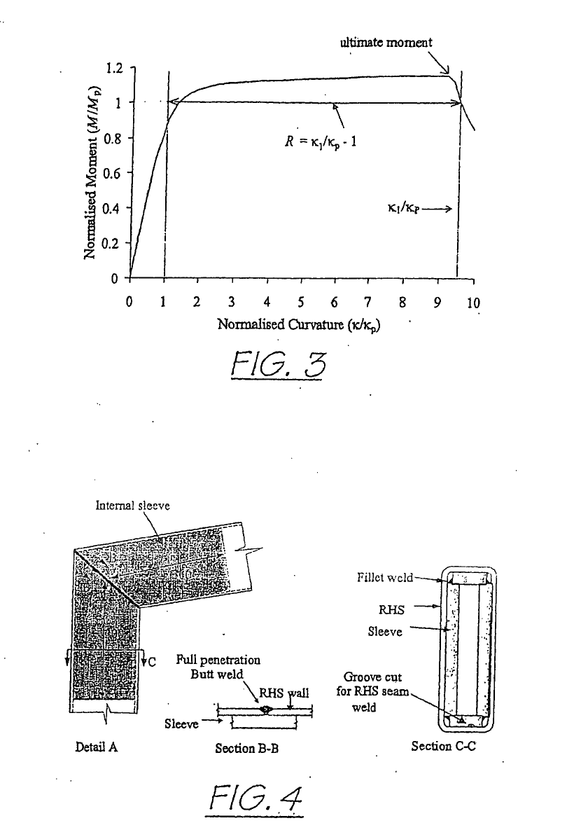

Since the rotation of a “plastic hinge” is related to the change in the maximum curvature of the plastic zone over time, the rotation capacity R of a structural section is typically defined as
R=K₁/Kₚ−1 (1)
in which K₁, is the curvature at which the bending moment at the plastic hinge drops below the plastic moment Mₚ, and Kₚ is the curvature at which the plastic moment is first reached (computed using the assumption of linear elastic behavior). This well-established definition is illustrated in FIG. 3, where the normalised bending moment M/mₚ is plotted against the normalised curvature K/Kₚ.

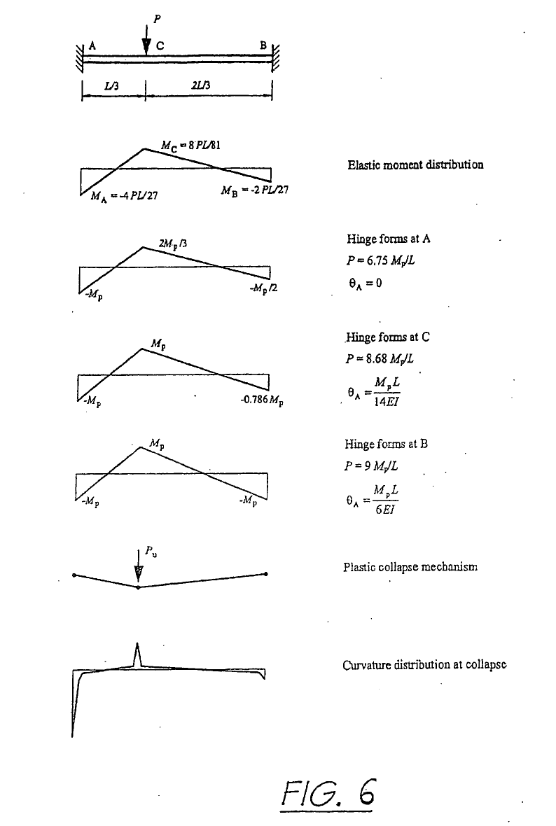

However, for a knee joint there are difficulties in measuring the rotation capacity defined in Equation (1). In order to circumvent these difficulties Wilkinson & Hancock (2000) “Tests to examine plastic behaviour of knee joints in cold-formed RHS,” Journal of Structural Engineering, ASCE, 126 (3), 297-305, proposed an alternative definition for welded knee joints:
R=(α₁−α₀)/(αₚ−α₀)−1 (2)
in which α₁ is the angle between the straight chords of the two connected members when the bending moment at the plastic hinge drops below the plastic moment Mₚ, α₀ is the initial angle in the unloaded state, and αₚ is the angle when the plastic moment is first reached (computed using the assumption of linear elastic behaviour). These variables are depicted in FIG. 7, where α_{d} is the angle at an arbitrary (loaded) state. The definition of rotation capacity in equation (2) is the preferred definition used in the present invention.

For a welded knee joint under opening moment, Wilkinson & Hancock (ibid) replaced the angle α₁ in equation (2) with the angle when fracture occurs (which for a compact RHS coincided with the ultimate bending moment). Such a definition of rotation capacity was appropriate for the stiffened welded knee joints tested by Wilkinson & Hancock (ibid), each of which underwent a precipitous drop from the ultimate moment to approximately the plastic moment, after which the rate of moment shedding decreased as fracture propagated into the web.

However, the preferred welded knee joints in accordance with the present invention, which fractured in the tension flanges, underwent significant additional rotations before the bending moments dropped below the plastic moment. The rotation capacity defined in Equation (2) was therefore adopted in the results set forth below.

The measurement of rotation capacity, whether based on Equation (1) or (2), was affected by the determination of the plastic moment Mₚ. The plastic moment is the bending moment that results in complete plasticisation of a cross-section (neglecting the limiting condition that the material surrounding the neutral axis will never yield under flexure alone). For a homogeneous and isotropic section with elastic-perfectly plastic material, the plastic moment is equal to the product of the plastic section modulus and the yield stress. Where the actual yield stress of such a section is available, then the actual plastic moment is readily computed.

However, this was not the case for a cold-formed RHS. In an RHS the yield stresses of the web, the flange and the corner of a cold-formed RHS differed significantly from each other. Further, strain-hardening of the steel caused an increase in the moment above Mₚ to the ultimate moment. In any case, the present inventors ascertained that an accurate measurement of the actual plastic moment of a DuraGal© C450 RHS was neither necessary nor meaningful in the context of assessing its suitability for plastic design.

Furthermore, the definition of rotation capacity, as expressed by either Equation (1) or (2), did not require that the plastic moment Mₚ used in the experimental study be the actual plastic moment that causes complete plasticisation of the section. The reliability of the plastic design method depended on the amount of rotation between the attainment of the assumed plastic moment Mₚ, in terms of which the design load capacity was expressed, and the point at which the bending moment drops below Mₚ. It did not depend on the actual plastic rotation.

Thus, for the purpose of determining the rotation capacity of a specimen tested in accordance with the present invention, the plastic moment Mₚ was computed as the product of the nominal plastic section modulus and the nominal yield stress of 450 MPa, as this is the value that will be used in the plastic design.

The present inventors recognised that, in a stiffened welded knee joint between compact RHS under opening moment, an important factor was the ductility of the most tensioned region, including the corners where fractures were found to be initiated. The inventors surprisingly discovered that stress concentrations could be redistributed away from the corners.

Improving Rotation Capacities Through Welding Techniques.

By relieving the effect of welding residual stresses and annealing the parent steel, the present inventors conceived the idea of welding in a manner that prevented the usual premature fracture of a welded knee or apex joint. The present inventors discovered that by using certain welding techniques, the plastic moment capacity of the section was not reduced (and coating damage of galvanised RHS was also advantageously limited).

Preferred Welding Techniques According to the Present Invention.

The present inventors conceived the idea of applying a spaced “buffer” weld bead transversely across the inner flange at a distance of approximately 15 mm from the stiffening plate, as shown in FIG. 10. The RHS member and the plate were then welded in the usual manner (typically using only one pass, which had been found to be sufficient) before an intermediate “closing” weld was laid between the first two welds as depicted in FIG. 11. FIGS. 11 and 12 show an example of such a connection.

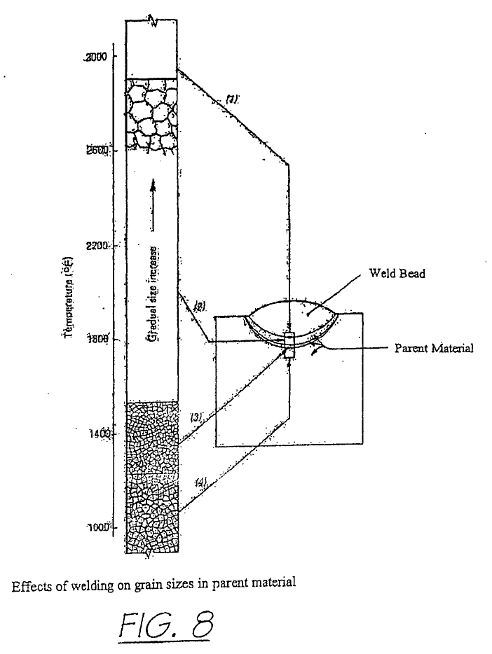

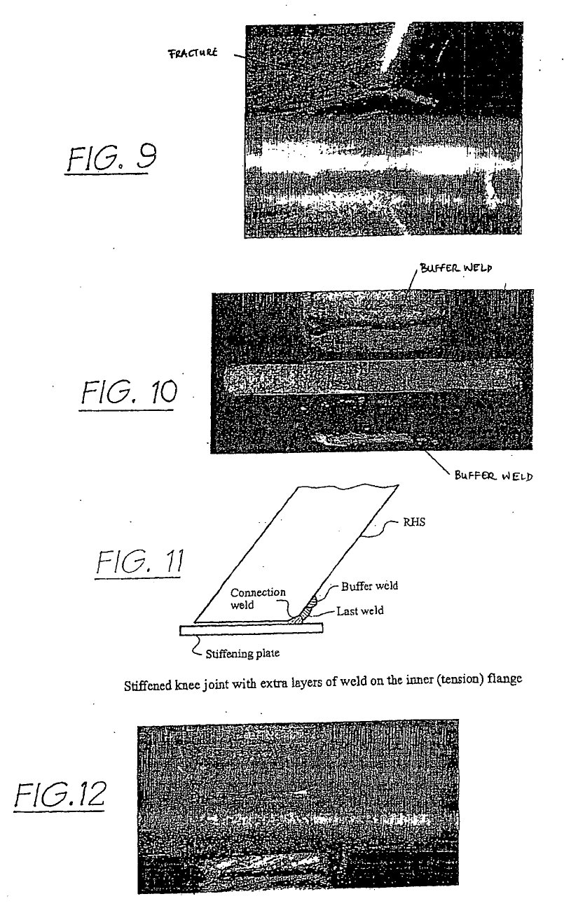

The extra layers of weld were observed to prevent premature fracture in the corner of the type shown in FIG. 9, and resulted in fracture taking place in the flange adjacent to the spaced buffer weld bead (as shown in FIG. 18), thus increasing the rotation capacity of the knee (or apex) joint. In knee joints subjected to uplift forces and in apex joints subjected to gravity loads, only the inner flange had the buffer weld deposited thereon.

The two most preferred ways of forming the extra layers of weld were referred to as the backward bead deposit sequence and the forward bead deposit sequence. These two sequences are illustrated in FIGS. 34(a) and (b) respectively.

In the backward bead deposit sequence, the buffer weld bead was laid before the intermediate and the reinforcement weld beads, at a distance d from the connection weld. The first intermediate weld bead was then laid adjacent to the buffer weld towards the connection weld as shown in FIG. 34(a), and subsequent intermediate weld beads were laid to form a continuous weld surface between the buffer weld and the connection weld. This sequence avoided heat accumulation in the flange area adjacent to the buffer weld away from the connection weld (i.e in the parent metal), and the highest temperature this area was subjected to was the temperature when the buffer weld was first laid (starting at room temperature). As a result, the heat-affected-zone in the flange area adjacent to the buffer weld was more limited than that resulting from the forward bead deposit sequence. The reinforcement weld was used to ensure that fracture did not take place adjacent to the stiffening plate.

For the purpose of illustration, the connection weld is shown in FIG. 34(a) as being laid before the buffer weld. However, as far as the efficacy of the backward bead deposit sequence was concerned, the connection weld was able to be laid before or after the buffer weld.

In the forward bead deposit sequence (FIG. 34(b), the first intermediate weld bead was laid adjacent to the connection weld. Subsequent intermediate weld beads were then laid away from the connection weld until the desired width d was obtained. The last “intermediate” weld bead constituted the buffer weld in this sequence. Unlike the backward bead deposit sequence, immediately before the buffer weld was laid, the flange area adjacent to the buffer weld was at a temperature much higher than room temperature. As a consequence, the heat-affected-zone resulting from this welding technique was more extensive than that resulting from the backward welding technique. Although not shown in FIG. 34(b), a reinforcement weld is also preferably used in conjunction with the forward bead deposit sequence.

The inventors also note that, for the purpose of minimising the heat-affected-zone, it is theoretically possible to use the forward bead deposit sequence provided that sufficient time is allowed to cool the flange area to room temperature before the buffer weld (and perhaps the last two intermediate weld beads) is laid. However, the inventors note that in some situations this may not be practical.

It can be seen from FIG. 30 that, in a specimen welded with the forward technique, so-called “necking” (or narrowing) of the flange occurred well within the heat-affected-zone. It can also be seen from FIG. 32 that, in a specimen welded with the backward technique, necking of the flange occurred outside the heat-affected-zone.

As the heat-affected-zone is generally associated with reduced ductility and reduced tensile strength, the inventors noted that, with other parameters being the same, the backward bead deposit sequence led to an even higher rotation capacity than the forward bead deposit sequence and is therefore the most preferred welding technique.

Strain Redistribution in Accordance with the Present Invention.

Based on statics and the engineering beam theory, the highest stressed region of a normally welded stiffened knee joint under opening moment is the inner flange immediately adjacent to the connection weld. However, in practice it was observed that fracture was invariably initiated in a corner as shown in FIG. 9.

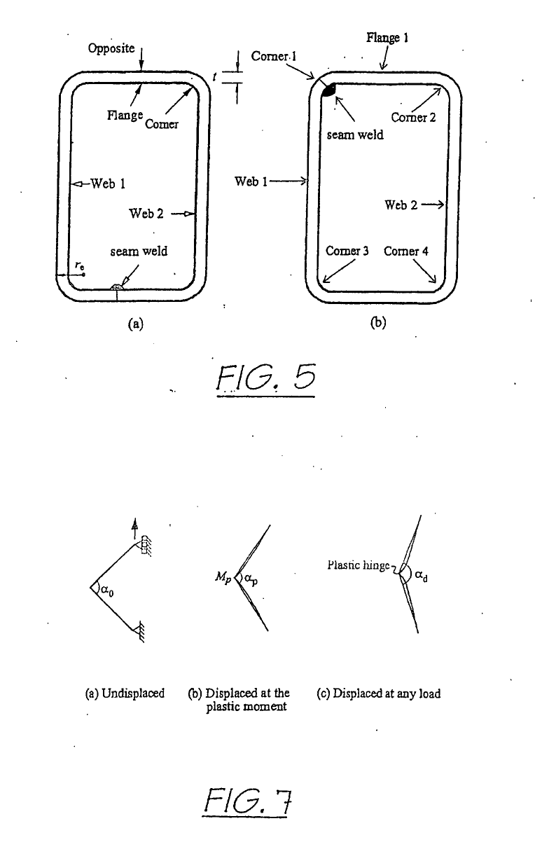

The inventors postulated two explanations for this phenomenon. The first was that the highly cold-worked corner material of a DuraGal C450 RHS had significantly reduced ductility compared to the flange material, as can be seen from FIG. 13 (to be read in conjunction with the nomenclature of FIG. 5). Referring also to FIG. 5, the “opposite” curve in FIG. 13 plots the result for a tension coupon cut from the flange that did not contain the seam weld of the tubular section. It was deduced that it was the material ductility and the strain level rather than the material strength and the stress level that determined where fracture were initiated.

It was also seen from FIG. 13 that even if the maximum strain of the unwelded flange was greater than that of the unwelded corner at the ultimate bending moment, the corner fractured before the flange. As discussed below, for a normally welded stiffened knee joint, the corners were in fact subjected to higher strains than the inner flange.

The second reason for corner fracture was that the engineering beam theory, which makes use of the Euler-Bernoulli assumption that a plane section that is normal to the centroidal line remains so after bending, is not valid for determining the strain distribution in the region adjacent to the stiffening plate, even in the linear elastic realm.

A linear finite element analysis of a stiffened knee joint welded in the normal way (Model 1) was used to predict that the greatest longitudinal normal strain was in the corner adjacent to the stiffening plate rather than in the flange. The corner of the 150×50×4 RHS model was assumed to have a middle wall radius of 6 mm. The geometry and the loading condition of the knee joint were as described in the Examples. Only one member was modelled, owing to joint symmetry, using the quadrilateral shell element with linear interpolation and reduced integration available in ABAQUS (Hibbitt, Karlsson & Sorensen 1998 Version 5.8, Pawtucket R.I., USA).

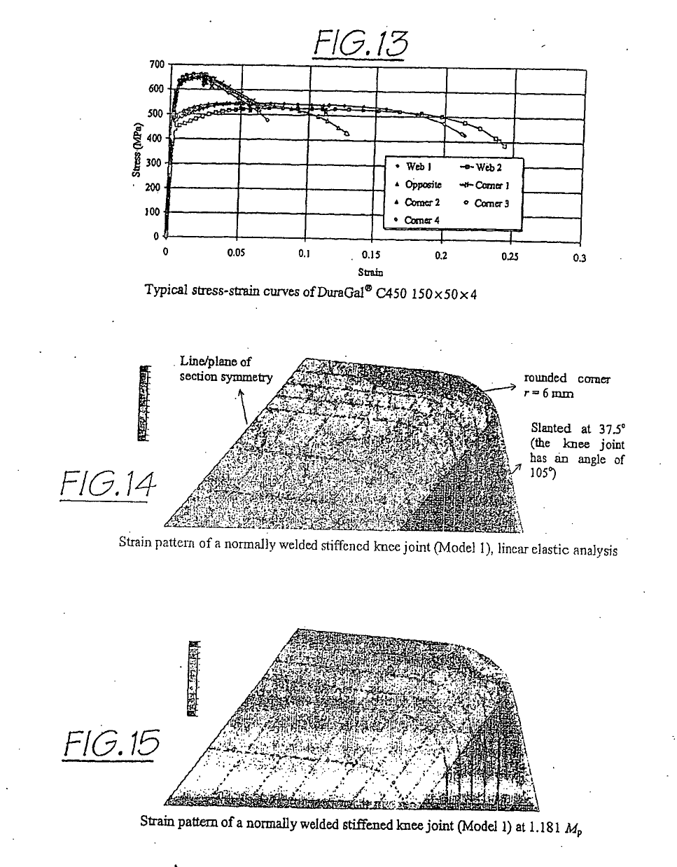

The connected end was assumed to be completely restrained. The contour of longitudinal normal strains in the neighbourhood of the inner flange at the connected end, which was slanted at the web, was then graphed as shown in FIG. 14. Only half of the RHS was modelled because of section symmetry. In FIG. 14, the darkest shading represented the highest tensile strain level.

The finite element model was then re-analysed, by incorporating geometric and material non-linearities. The web was assumed to have a yield stress of 450 MPa, the flange 480 MPa, and the corner 620 MPa, all without strain hardening. For the sake of simplicity and clarity, residual stresses were not modelled in the analysis. FIG. 15 shows the contour of longitudinal normal strains at a maximum bending moment of 1.181 times the nominal plastic moment Mₚ. It was seen that the strain concentration in the corner did not disperse as a plastic zone developed around the connection (in fact, it became even more intense). The maximum longitudinal normal strain in the corner was 0.300, almost three times that in the flange, which was only 0.122.

The present inventors therefore conceived the idea that in order to avoid fracture initiation in the corner, the extra layers of weld shown in FIG. 12 must “absorb” strains from the corners. In a Model 2 finite element analysis, the extra layers of weld and the underlying flange were modelled together as shell elements of thickness equal to twice the flange thickness of the 150×50×4 RHS. The extra weld was assumed to have a yield stress of 480 MPa, and was modelled as being 20 mm wide from the connected end. The extra layers of weld were assumed to start from and end at the middle of the opposing corners (six strips as measured from the line of section symmetry).

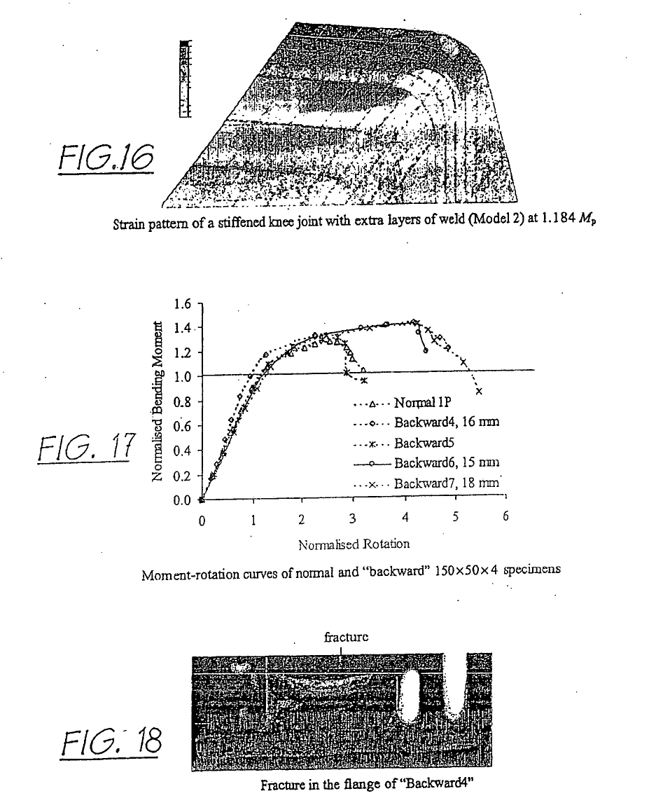

It was seen from the contour of longitudinal normal strains determined using the geometrically and materially non-linear analysis, as shown in FIG. 16, that the extra layers of weld absorbed strains from the corner at the connected end when a plastic zone formed at a bending moment of 1.184 times Mₚ. The greatest strains were now in the flange region adjacent to the buffer weld (corresponding to the fracture zone), which peaked at 0.037. Importantly, the maximum strain in the corner dropped drastically from 0.300 (at 1.181 Mₚ) to 0.032.

It was noteworthy that in the elastic realm, the greatest strains were in the corner, as predicted by the linear elastic analysis result of the same model (Model 2). As the plastic zone developed further, the extra layers of weld on the inner flange redistributed even more strains from the corners to the flange region adjacent to those corners.

Another important result was that, under the same load, the maximum longitudinal normal strain in the flange region adjacent to the buffer weld (0.037 at 1.184 Mₚ) was less than half its value without the buffer weld (0.093 at 1.181 Mₚ). Thus the extra layers of weld not only shifted the strain concentration away from the corners into the flange region adjacent to the buffer weld, but also redistributed a significant amount of strain away from the latter. This result was in contrast to the prediction based on the engineering beam theory that the strains remained the same with or without the buffer weld. As was found in laboratory tests (discussed below) fracture in a stiffened welded knee joint having the extra layers of weld on the inner (tension) flange was initiated in the flange region adjacent to the buffer weld. The extra layers of weld thus led to a significantly increased rotation capacity as well as an increased moment capacity.

A finite element analysis on the effects of the dimensions of the extra layers of weld on the strain distribution around a stiffened welded knee joint between 150×50×4 or 150×50×5 RHS members was performed. Comparisons between different models were carried out at a given rotation.

Table 1 lists the maximum strains in the flange region adjacent to the buffer weld and in the rounded corner adjacent to the stiffening plate at a normalised rotation of approximately 4, of models having various dimensions of the extra layers of weld on their respective inner flanges.

TABLE I
Maximum strains in different regions of various models at a normalised
rotation of approximately 4; 150 × 50 × 4 RHS

| | |
|---|---|
| Extra layers of weld | Maximum strain |

| | Width | Thickness | | Corner at |
|---|---|---|---|---|
| Model | (mm) | (mm) | Flange | welded end |
| 1 | 0 | 0 | 0.122* | 0.300 |
| 3 | 10 | 4 | 0.122 | 0.060 |
| 4 | 18 | 4 | 0.072 | 0.068 |
| 5 | 18 | 3 | 0.064 | 0.088 |
| 6 | 18 | 5 | 0.076 | 0.050 |

*adjacent to the stiffening plate

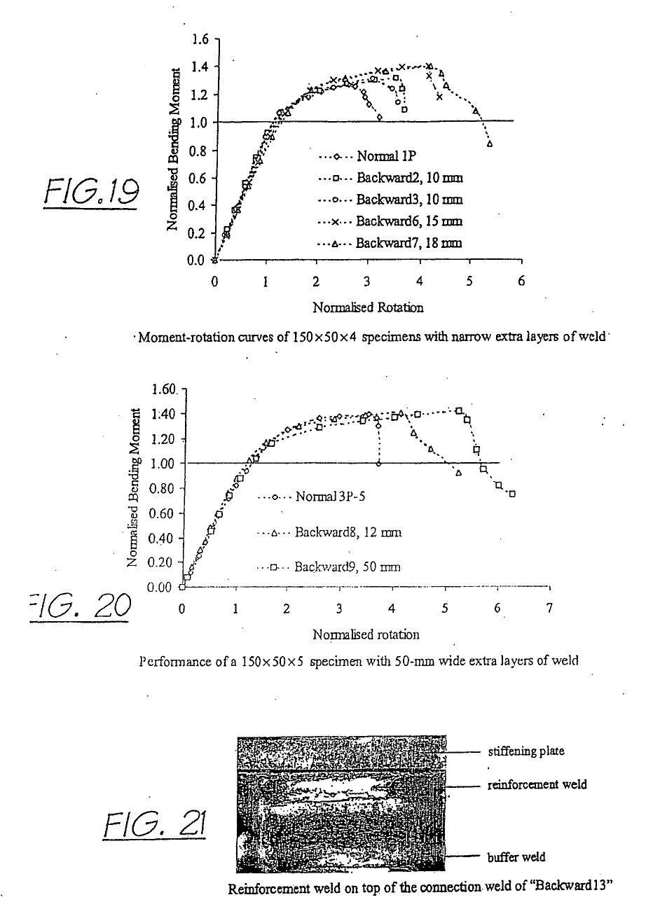

At a given normalised rotation of 4, the greatest strain of Model 1 (0.300) was well beyond the fracture strain of the unwelded corner material shown in FIG. 13 (0.07). Also, FIG. 19 (discussed below) indicated that the specimen “Normal 1P” fractured at a normalised rotation of approximately 2.6. At this rotation, the finite element analysis predicted the greatest strain in the corner to be 0.190.

The preceding discussion refers to stiffened welded knee joints between 150×50×4 mm RHS members. Table 2 lists the maximum strains in the flange region adjacent to the buffer weld and in the rounded corner adjacent to the stiffening plate of various 150×50×5 mm RHS finite analysis models at a normalised rotation of approximately 4.

TABLE 2
Maximum strains in different regions of various models at a normalised
rotation of approximately 4; 150 × 50 × 5 RHS

| | |
|---|---|
| Extra layers of weld | Maximum strain |

| | Width | Thickness | | Corner at |
|---|---|---|---|---|
| Model | (mm) | (mm) | Flange | welded end |
| 7 | 12 | 4 | 0.124 | 0.095 |
| 8 | 20 | 4 | 0.078 | 0.089 |
| 9 | 30 | 4 | 0.077 | 0.077 |
| 10 | 30 | 3 | 0.064 | 0.08S |
| 11 | 50 | 4 | 0.073 | 0.148 |

A finite element analysis was also made on the applicability of extra layers of weld to a fixed base column connection which has a right angle rather than a slanted connected end. Also, in a base column connection there is no distinction between closing and opening moments. Furthermore, the column is almost invariably subjected to compression rather than tension.

Regardless of the fact that the normally welded base column connection may not fail by premature fracture, the finite element analysis result of the base column model having the 18-mm wide and 3-mm thick extra layers of weld on both flanges suggested that fixed base column connections could also benefit from the extra layers of weld.

Table 3 lists the maximum strains in the flange and in the corner of a normally welded fixed base column connection, a normally welded stiffened knee joint without axial loading, and a fixed base column connection with extra layers of weld on both flanges, at a normalised rotation of 2.45.

TABLE 3
Maximum strains in different regions of various models at
a normalised rotation of 2.45; 150 × 50 × 4 RHS

| | | Extra layers of weld | | Maximum strain | |
|---|---|---|---|---|---|
| | | Width | Thickness | | Corner at |
| Model | Slanted | (mm) | (mm) | Flange | welded end |
| 12 | No | 0 | 0 | 0.032 | 0.047 |
| 13 | Yes | 0 | 0 | 0.055 | 0.164 |
| 14 | No | 18 | 3 | 0.025 | 0.013 |

### EXAMPLES

### Experimental Test Results

The following welding procedures for the connection welds of the knee joints were employed.

Welding procedures for heat treated specimens

| Parts welded: | 150 × 50 × 4 RHS to 10-mm plate |
|---|---|
| Joint Preparation: | 2 mm gap, bevelled edge |
| Welding Position: | Horizontal (2F) |
| Welding Process: | GMAW, short-arc transfer |
| Welding Machine: | CIG Transmig 330 transformer; Transmig 2Rse |
| | feeder |
| Polarity: | DCEP |
| Stick-out: | 15 mm |
| Electrode Trade Name: | CIGWeld Autocraft |
| Gas Trade Name: | Argoshield 51 |
| Gas Composition: | 16% CO₂, 81.5% Ar, 2.5% O₂ |
| Gas Flow Rate (L/min) | 25 |

| | Electrode | Wire | | | Welding | Arc |
|---|---|---|---|---|---|---|
| | Classi- | Speed | | | Speed | Energy |
| Weld | fication | mm/min | V | A | mm/min | kJ/mm |
| Flange, R1 | 0.9 mm | 8500 | 24 | 260 | 250 | 1.50 |
| Flange, R2 | ES4-GC/M- | | | 245 | 275 | 1.28 |
| Flange, R3 | W503AH | | | 190 | 320 | 0.86 |
| Web, R1 | | | | 215 | 300 | 1.03 |
| Web, R2 | | | | 245 | 350 | 1.01 |
| Web, R3 | | | | 215 | 455 | 0.68 |

| | |
|---|---|
| Parts welded: | 150 × 50 × 5 RHS to 10-mm plate |
| Joint Preparation: | 2 mm gap, bevelled edge |
| Welding Position: | Horizontal (2F) |
| Welding Process: | GMAW, short-arc transfer |
| Welding Machine: | CIG Transmig 330 transformer, Transmig 2Rse |
| | feeder |
| Polarity: | DCEP |
| Stick-out: | 15 mm |
| Electrode Trade Name: | CIGWeld Autocraft |
| Gas Trade Name: | Argo shield 51 |
| Gas Composition: | 16% CO₂, 81.5% Ar, 2.5% O₂ |
| Gas Flow Rate (L/min) | 25 |

| | Electrode | Wire | | | Welding | Arc |
|---|---|---|---|---|---|---|
| | Classi- | Speed | | | Speed | Energy |
| Weld | fication | mm/min | V | A | mm/min | kJ/mm |
| Flange, R1 | 0.9 mm | 8500 | 24 | 255 | 360 | 1.02 |
| Flange, R2 | ES4-GC/M- | | | 260 | 480 | 0.78 |
| Flange, R3 | W503AH | | | 255 | 530 | 0.69 |
| Web, R1 | | | | 235 | 315 | 1.07 |
| Web, R2 | | | | 240 | 390 | 0.89 |
| Web, R3 | | | | 235 | 370 | 0.91 |

Only one pass (denoted R1 in the tables) was used for each connection weld, except for specimen “Normal 3P-5” where three passes were used.

The following welding procedure for the extra layers of weld was employed.

| Parts welded: | Flange of 150 × 50 × 4 RHS |
|---|---|
| Welding Position: | Flat (1F) |
| Welding Process: | GMAW, short-arc transfer |
| Welding Machine: | CIG Transmig 330 transformer; Transmig 2Rse |
| | feeder |
| Polarity: | DCEP |
| Stick-out: | 15 mm |
| Electrode Trade Name: | CIGWeld Autocraft |
| Gas Trade Name: | Argoshield 51 |
| Gas Composition: | 16% CO₂, 81.5% Ar, 2.5% O₂ |
| Gas Flow Rate (L/min) | 25 |

| | Electrode | Wire | | | Welding | Arc |
|---|---|---|---|---|---|---|
| | Classi- | Speed | | | Speed | Energy |
| Weld | fication | mm/min | V | A | mm/min | kJ/mm |
| Buffer weld | 0.9 mm | 8500 | 25.5 | 285 | 750 | 0.58 |
| Closing weld | ES4-GC/M- | | | 280 | 545 | 0.79 |
| | W503AH | | | | | |

This resulted in an average weld thickness of about 2 to 4 mm. It was noted that it was not practicable nor necessary to maintain a uniform thickness of the extra layers of weld over the inner flange, nor were undulations between passes (weld beads) critical. Provided that fracture was initiated in the flange region adjacent to the buffer (spaced) weld, the variation in the extra weld thickness was not important.

Experimental Procedure

Stiffened welded knee joints using DuraGal C450 150×50×4 or 150×50×5 RHS members were tested. The connected RHS members of each knee joint had an angle of 105° with respect to each other. Thus, the connected end of each member was slanted at 37.50°. Symmetrical members were welded to a 10-mm thick stiffening plate at the joint.

A pin (40 mm in diameter) was inserted through a circular hole in the RHS webs near each free end, which had a diameter of 42 mm. Reinforcement plates were used to strengthen the web material around the hole (although were often unnecessary due to the relatively low bearing loads applied in the tests). The two pins acted as both supports and loading points since they were anchored to grips of a hydraulic ram. An upper grip was attached to a loading ram of a servo-controlled testing machine, a 2000-kN capacity Dartec. In the experiment, the loading ram moved upwards to create tensile axial loading and opening bending moment in the knee joint specimen. The initial stroke rate was 5 mm/minute, decreasing to 1 mm/minute as the plastic moment was approached.

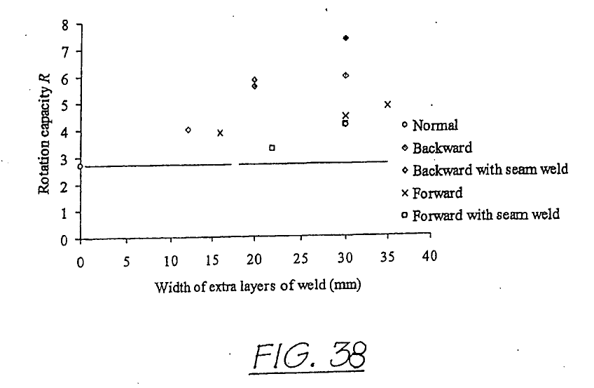

A schematic diagram of the load(s) applied to the specimen is shown in FIG. 36. From this diagram, it can be seen that for each member, the axial load F was approximately 1.3 times the transverse shear load V, increasing with the opening of the knee joint. However, as the bending moment at the knee joint was equal to approximately 867.5 V (see next paragraph), the contribution of the axial load F to the longitudinal normal stresses and strains around the connected end was small. At the nominal plastic moment of 29.4 kNm for a C450 150×50×4 RHS specimen, the uniform normal stress due to the axial load was about 5% of the nominal yield stress of 450 MPa.

In the structural analysis of a frame, the joint coordinates and member lengths are usually determined based on the intersections of the centroidal lines of the members. Accordingly, the length of each connected member of the knee joint specimen was measured along the centroidal line from the loading/support point to the stiffening plate, which was approximately 867.5 mm. The loading/support point was assumed to be located at the centre of the circular hole. The bending moment at the joint was computed as the product of the applied load P and the horizontal distance e between the loading point and the centre line of the joint (see FIG. 36).

In order to account for the second-order effect due to geometric non-linearity on the bending moments in the knee joint, a transducer was used to measure the horizontal displacements of the joint. For this purpose, a steel strip was tack-welded to the stiffening plate, noting that the loading ram could not move in the horizontal direction. As the connected members were largely symmetrical until fracture, the steel strip remained vertical for most of the test duration.

The rotation of the knee joint, as illustrated by FIG. 7, was computed from the stroke displacement of the loading ram and the horizontal displacement of the stiffening plate.

Non-limiting experimental examples using this procedure will now be described.

### Example 1

FIG. 17 shows the laboratory test results of stiffened knee joints between DuraGal C450 150×50×4 RHS, welded using various procedures. It can be seen that the stiffened knee joint specimens welded using the weld bead deposition sequence depicted in FIG. 11, and denoted “Backward4” and “Backward6 ”, had significantly greater rotation capacities than the specimen welded in the normal (no extra welds) way, denoted “Normal 1P”. In FIG. 17, the number in millimeters following a specimen designation indicates the width of the extra layers of weld.

It was significant that with preferred welded specimens, fractures were found to be initiated in the flanges rather than the corners, as evident from FIG. 18. The stiffer moment-rotation curve of “Backward4” was caused by the fact that the specimen was unloaded when the maximum bending moment was close to the nominal plastic moment in order to install a horizontal transducer, and was then reloaded until failure. “Backward7” was welded in the same manner as the other “backward” specimens, except that there were two closing (intermediate) welds. This specimen had an acceptable rotation capacity R slightly greater than 4, as would “Backward4” if the bending moment had dropped below Mₚ. The tests of “Backward4” and “Backward6” were terminated before their bending moments dropped below the nominal plastic moment in order to show that fractures were not initiated in the corners.

The “Backward5” specimen did not outperform the normal specimen as a gap was introduced between the connection weld and the closing weld. In “Backward5” fracture was initiated in the corner and propagated through the gap, illustrating the importance of a continuous weld surface in the bead deposition sequence.

### Example 2

Other specimens were welded in the manner depicted in FIG. 11, but with narrower widths of extra layers of weld. These other specimens had reduced rotation capacities compared with the successful “backward” specimens discussed in Example 1. FIG. 19 shows the rotation capacities of such specimens. This example demonstrated that for the stiffened welded knee joints between DuraGal C450 150×50×4 RHS, a desirable increase in rotation capacity was best ensured where width of the extra layers of weld on the inner flange was at least 15 mm.

The laboratory test results also supported the finite element analysis; ie. reducing the width of the extra layers of weld from 18 mm to 10 mm considerably increased the maximum longitudinal normal strain in the flange (where fractures of the test specimens were initiated) at a given rotation.

### Example 3

As also indicated by finite element analysis, there was a limit to the width of the extra layers of weld beyond which fracture would take place adjacent to the stiffening plate. FIG. 20 shows the test results of two stiffened knee joints between DuraGal C450 150×50×5 RHS. It can be seen that although the width of the extra layers of weld in “Backward8” was 12 mm while that in “Backward9” was 50 mm, their normalised rotations differed from each other by 10% only. In fact, fracture of “Backward9” was initiated in the connection weld and propagated in the weld metal across the flange. Finite element analysis predicted excessive strain concentration in the corner at the connected end.

### Example 4

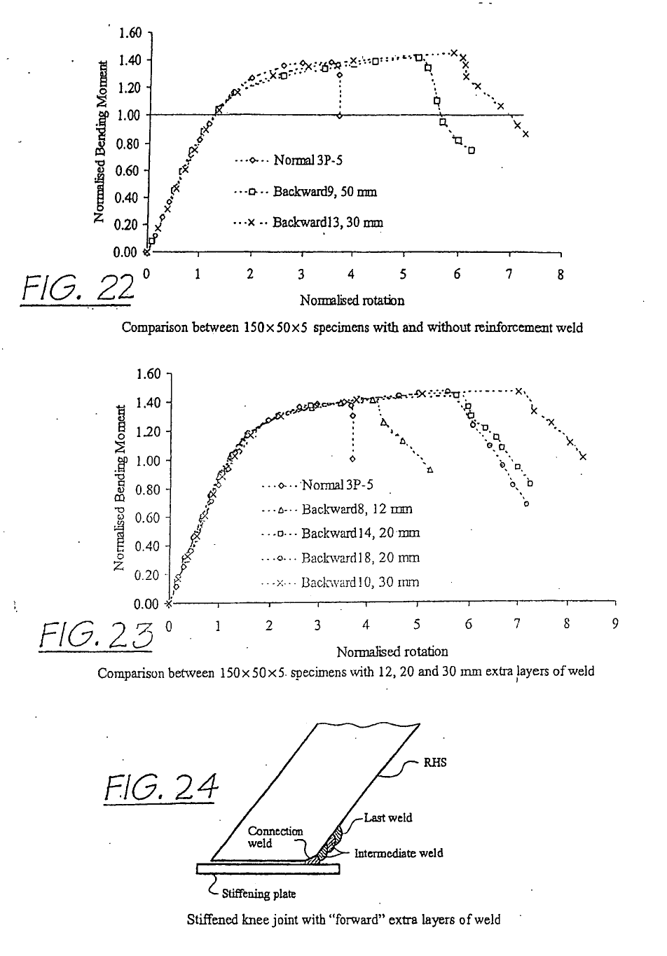

As stated in Example 1, it was found there was a gap in “Backward5”, which led to premature fracture. The inventors developed a simple technique for preventing fracture adjacent to the stiffening plate. The technique involved adding one layer (bead) of “reinforcement” weld on top of the connection weld, as shown in FIG. 21 for “Backward13”. The result of this was plotted in FIG. 22.

### Example 5

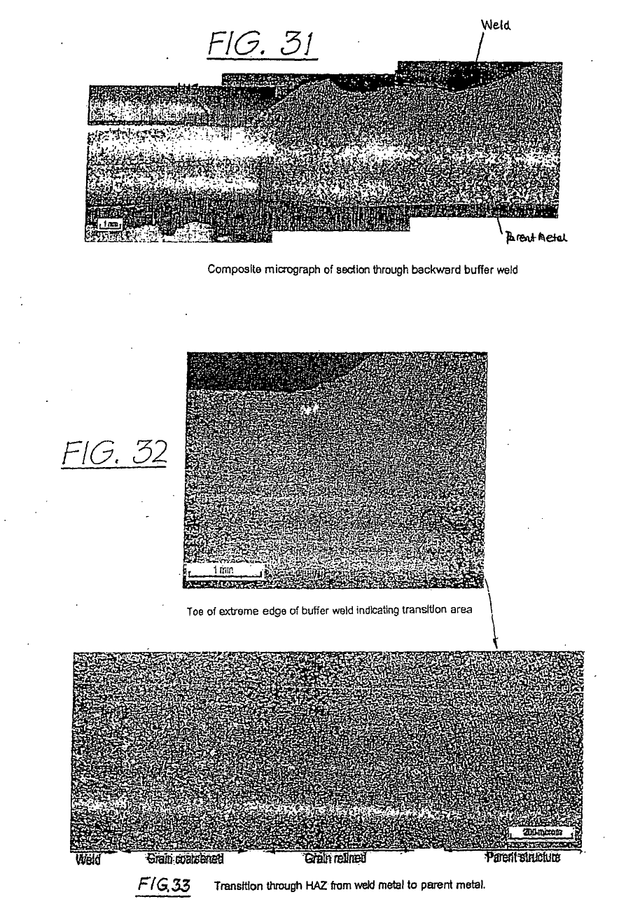

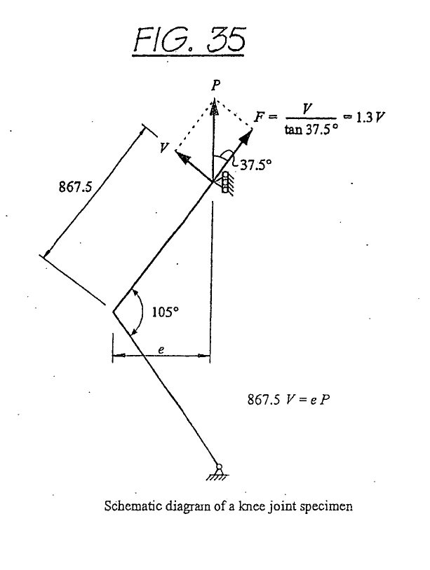

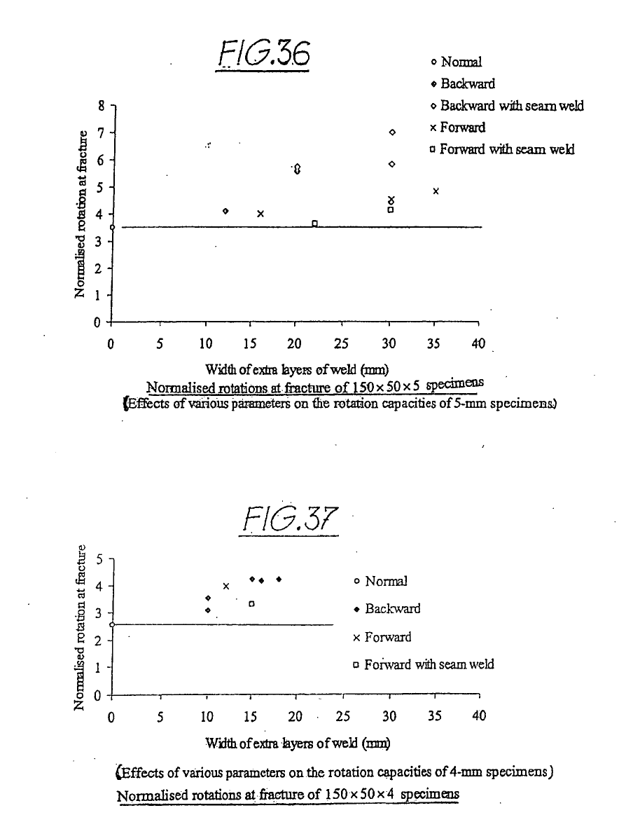

An alternative to the “backward” welding (or bead deposit) sequence depicted in FIG. 11 is depicted in FIG. 24, and is termed the “forward” welding (or bead deposit) sequence. In the “forward” welding sequence the flange material adjacent to the buffer weld (the last weld in FIG. 24) did not benefit from the reduced heat affected zone as shown in FIGS. 29 and 31. This is discussed further in Examples 8 and 9.

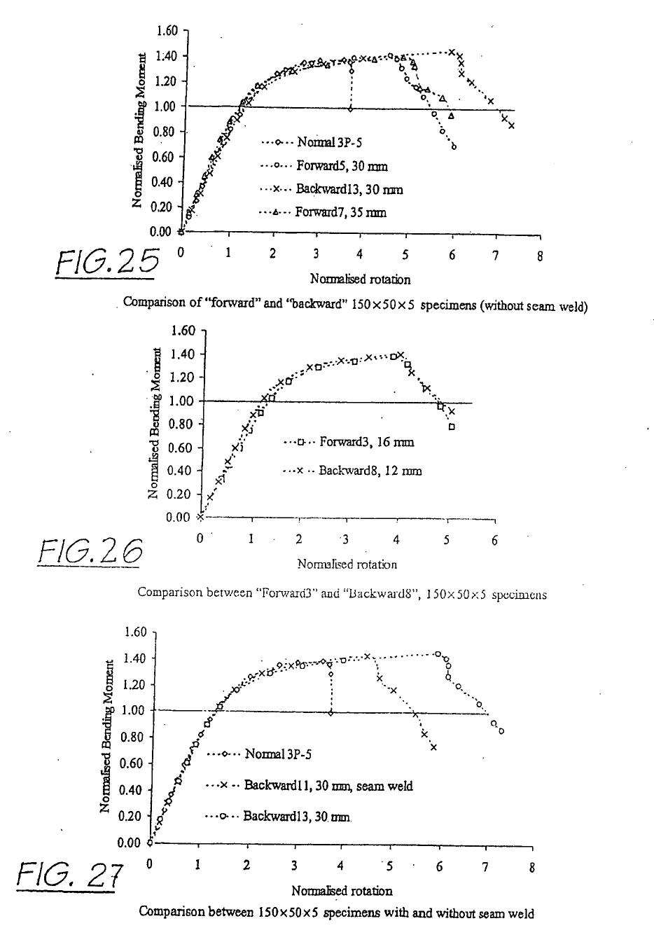

Two specimens otherwise similar to “Backward13” were fabricated using the “forward” welding sequence and were tested in the same manner. FIG. 25 shows that the “forward” welding sequence yields acceptable results but does not yield as good results as the “backward” welding sequence.

### Example 6

The fact that a “backward” specimen is superior to a “forward” specimen is also evident in this example. The widths of the extra layers of weld in “Forward3” and “Backward8” were 16 mm and 12 mm, respectively (which were in the desirable range). Despite having the wider extra layers of weld, it can be seen from FIG. 26 that “Forward3” did not have a greater rotation capacity than “Backward8”. Nevertheless, the forward welding technique still provided significantly improved results over a Normal specimen.

### Example 7

In the previous Examples the RHS was oriented such that the specimens all had the RHS seam weld located in the outer (compression) flange. In an RHS, there are longitudinal as well as transverse residual stresses associated with the seam weld (ie. as a result of differential seam weld cooling, differential metal contraction etc). Furthermore, the properties of the material in the vicinity of the seam weld may be quite different from those of the surrounding “parent” material.

In order to investigate the effect of the seam weld on rotation capacity, a specimen similar to “Backward13” was fabricated with the inner (tension) flange containing the seam weld. This specimen was designated “Backward 11”. FIG. 27 compared the performance of the two specimens. It can be seen from FIG. 27 that although “Backward 11” had a rotation capacity R greater than 4, the presence of the seam weld in the inner flange led to significant reduction in the ductility of the flange region adjacent to the buffer weld. The test also showed that fracture was initiated in the vicinity of the seam weld.

Definitive evidence that fracture had a propensity to occur in the vicinity of the seam weld was provided by a 150×50×4 specimen which was designated “Forward1”. This specimen was unusual in that the seam weld was located along the corner of the tubular section, as depicted in FIG. 5(b). With this unique position of the seam weld, fracture of “Forward1” was initiated in the corner, despite the presence of the extra layers of weld. For all other “forward” specimens, where the seam weld was located either in the compression flange or in the tension flange away from the corner, fracture was initiated within the flat face of the tension flange.

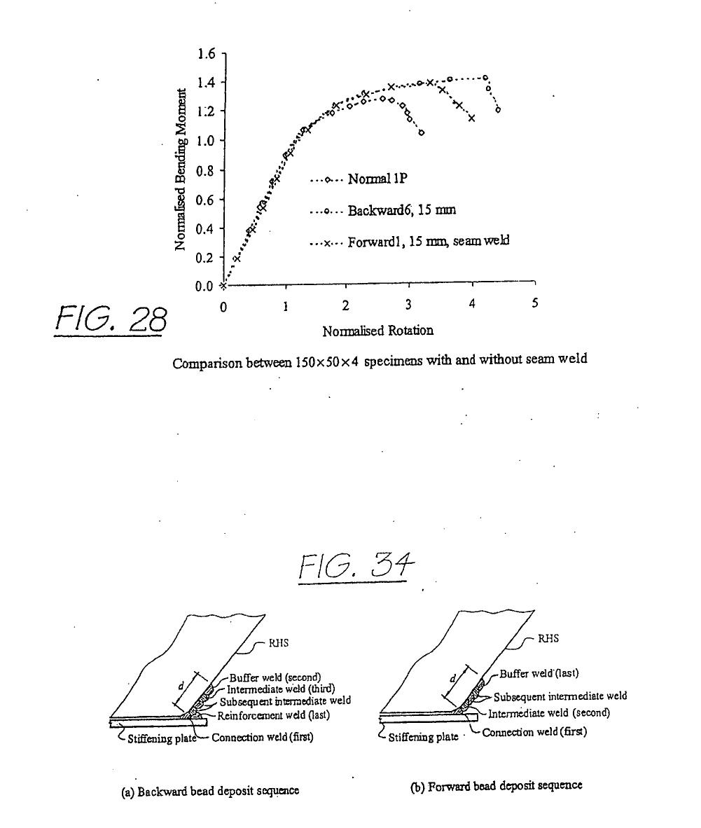

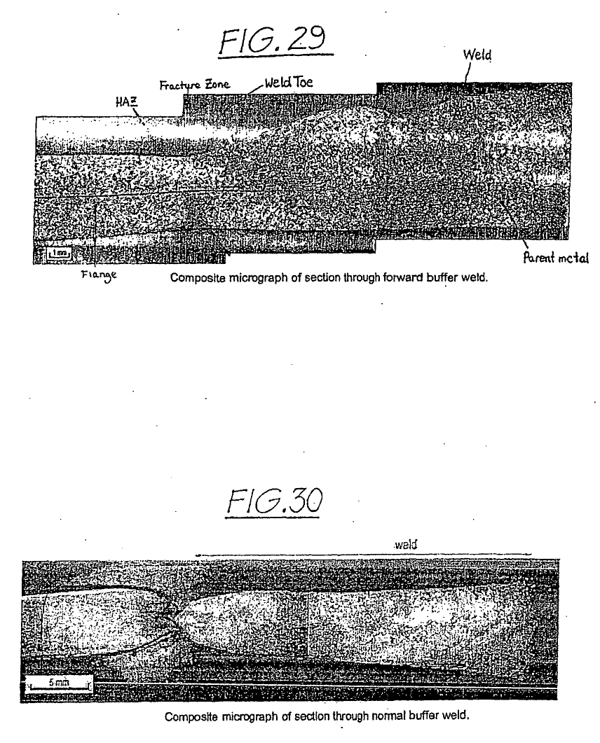

The moment-rotation curve of “Forward1” was plotted in FIG. 28, which also showed the curve of “Backward6” discussed in Example 1. It can be seen that fracture of “Forward1” took place at a lower rotation than “Backward6”, although the specimens had the same width of extra layers of weld.

As can be deduced from FIGS. 26 and 27, the effect of the “forward” welding sequence and seam weld location are similar to each other, and can affect the rotation capacity of a stiffened welded knee joint between DuraGal C450 150×50×5 RHS.

Minimising the Heat Affected Zone.

Experiments were conducted to investigate how minimisation of the extent to which the heat affected zone aligned with the fracture zone in a welded knee joint could be used in an effective manner to improve the rotation capacity of the joint. More particularly, the inventors surprisingly recognised that if the location of the heat affected zone (HAZ) extending through an RHS could be controlled, then the rotation capacity of a welded knee joint (and the like) could be improved.

Microstructure examinations were also conducted to investigate the differences in the width of the heat-affected-zones resulting from the backward and the forward bead deposit sequences. The alignment of the necked section (where fracture took place) with respect to the heat-affected-zones was also investigated.

### Example 8

Referring in particular to FIGS. 29 and 30, the “forward” welded knee joint was prepared. FIG. 29 illustrates a composite micrograph of a section taken through the “forward” specimen adjacent to a “toe” of the weld. FIG. 29 illustrates that the fracture zone is located at the end of the weld toe and extends through a flange of the RHS. In addition, the heat affected zone (HAZ) resulting from the welding of the joint in accordance with the present invention substantially aligns, overlaps and interfuses with the fracture zone. This is because in the forward welding sequence weld beads are deposited moving out from the connection weld, with the last laid bead terminating at the weld toe. Thus, when the buffer weld was laid, the region adjacent to the toe of the weld, which corresponded with the fracture zone, was subject to a temperature that was much higher than that incurred when the buffer weld was the first weld to be laid (under room temperature) in the backward welding technique.

FIG. 30 shows a composite micrograph through the “forward” welded specimen of FIG. 29 after it was subjected to load in accordance with the testing procedures outlined above. It can be seen that the specimen fractured along the fracture zone but also significantly within the heat-affected zone. Because of this alignment of the fracture and heat-affected zones, the specimen was relatively weaker in this region, thereby reducing the rotation capacity of the welded knee joint.

### Example 9

Referring now to FIGS. 31 to 33, composite micrographs through a welded knee joint formed using a “backward” bead deposit sequence are depicted. As can be clearly seen from FIG. 31, the bulk of the heat-affected zone did not align or lie within, or interfuse with the fracture zone. In fact, in some specimens, such as shown in FIG. 32, only the upper left tip of the heat-affected zone coincided with the fracture zone.

Because the bulk of the heat affected zone underlay the weld, which defined a thicker part of knee joint, the overall strength of the joint was improved in the vicinity of the weld.

### Example 10

Based on the experimental test results and finite element analysis, a preferred weld bead deposition sequence was developed, as depicted in FIG. 34(a). The connection weld and the buffer (spaced) weld were the first two weld beads deposited on the inner flange, but either could be laid before the other. The intermediate welds were then laid, starting adjacent to the buffer weld. For the tested specimens, excellent results were achieved when the thickness of the extra layers of weld were between 0.3 and 0.6 times the wall thickness of the rectangular hollow section. Adjacent to the stiffening plate, the reinforcement weld itself was then laid to desirably be at least half the section thickness and wide enough to cover the connection weld as well as the adjacent closing (or last deposited intermediate) weld. The number of intermediate welds laid depended on their sizes and RHS dimensions, and extra layers of weld were able to be laid on top of another to achieve the minimum thickness recommended.

### DISCUSSION AND ANALYSIS OF RESULTS

Rotation Capacity and Plastic Moment.

In these procedures the appropriate definition adopted for the rotation capacity of a knee joint under opening moment was that proposed by Wilkinson & Hancock (ibid), which was based on the assumption that the rotation was concentrated at the knee joint.

The terminal point for measuring rotation capacity should not be the point of local buckling or fracture, but the point where the bending moment at the plastic hinge drops back below the nominal plastic moment. For the purpose of investigating the suitability of a steel section for plastic design (neglecting the issues of efficiency and optimisation), the exact value of the plastic moment was largely immaterial. The plastic moment of a specimen was computed as the product of the nominal yield stress and the nominal plastic section modulus.

Factors Contributing to the Lack of Rotation Capacity.

A number of factors that contributed to the lack of rotation capacity of a normally welded stiffened knee joint between DuraGal C450 150×50×4 mm or 150×50×5 mm RHS under opening moment were identified and investigated. These factors included the welding residual stresses orthogonal to the applied bending stresses, the embrittlement effect of the welding process, the strain concentration in the rounded corner at the connected end, and the reduced elongation at fracture of the highly cold-worked corner material.

Use of Extra Layers of Weld as a Solution.

The inventors were successful in their prediction regarding the use of extra layers of weld on the inner (tension) flange of a stiffened welded knee joint to increase its rotation capacity under opening moment. This hypothesis was verified through the experimental tests and finite element analyses described above. In particular, the experimental tests verified that the specimens having extra layers of weld possessed significantly greater rotation capacities than the normally welded specimens. Fractures of such specimens were found to be initiated in the flange region adjacent to the buffer (spaced) weld.

The degree of increase in rotation capacity depended on a number of factors, including the width of the extra layers of weld, the weld thickness and the welding sequence. The width of the extra layers of weld was identified as an important factor, where the layers (beads) were sufficiently thick to prevent fracture from taking place adjacent to the stiffening plate.

Finite element analysis results indicated that the extra layers of weld had a desirable effect on the strain distribution around a stiffened welded knee joint. In particular, the extra layers of weld would reduce the maximum longitudinal normal strain in the RHS corner adjacent to the stiffening plate by 80% at a given rotation. The finite element analysis results supported the experimental test results, which showed that fractures of the specimens were not initiated in the corners.

It was also found through the experimental tests that the presence of the seam weld in the inner flange reduced the rotation capacity of the specimens having extra layers of weld on the inner flange, but not to the extent of rendering them unacceptable. It was also found that the use of the “forward” welding sequence for the extra layers of weld had a similar effect.

The effects of the various parameters are summarised in FIGS. 36 and 37 for the tested 5-mm and 4-mm specimens, respectively.

### ADVANTAGES OF THE INVENTION.

A number of advantages can be identified for the present invention. These include:

The use of internal sleeves (as illustrated in FIG. 4) and other reinforcement can be eliminated.
The preferred welding techniques (for example, as illustrated in FIG. 34) can be applied to both new and existing structures (assuming the joints are accessible for welding).
The preferred welding techniques redistributed the strains around stiffened welded knee, apex and other joints.
Preferred “backward” welding techniques limited the extent of the heat-affected-zone.
Where plastic design using rectangular, square or other polygonal hollow sections is permitted, the preferred welding techniques enabled the load-carrying capacity of an existing frame (eg. a portal frame) to be upgraded, even where there was a seam weld in the inner flange.
Finite element analysis indicated that the preferred welding techniques also reduced the strains in the corners of the connected end of an RHS to a fixed column base.
The welding methods are applicable to other cold-formed hollow sections produced using different manufacturing techniques. As such, these other hollow sections can be provided with sufficient rotation capacity required for plastic design.
Welded joints can be provided with sufficient rotation capacity and moment capacity such that RHS and other PHS can be applied in seismic applications.

Whilst the invention has been described with reference to a number of preferred embodiments, it should be appreciated that the invention can be embodied in many other forms.

1. A method for welding an end of a polygonal hollow section (PHS) to a member comprising the step of forming a weld across a surface of the PHS, the weld extending continuously from a connection weld connecting the PHS and the member to a location remote from the connection weld.

2. A method as claimed in claim 1 wherein the surface of the PHS is one or more flanges of the PHS.

3. A method as claimed in claim 2 wherein the PHS is an RHS or SHS, and the surface is part of just one flange.

4. A method as claimed in claim 2 wherein the continuous weld is applied to a tensile flange or flanges of the PHS.

5. A method as claimed in claim 1 wherein the continuous weld is formed by applying a plurality of weld beads to the surface.

6. A method as claimed in claim 1 wherein the step of forming the continuous weld comprises the steps of:
applying the connection weld across an edge of a flange of the PHS at the end thereof to connect the PHS to the member;
applying a weld bead across the flange that is spaced from the connection weld bead;
applying one or more intermediate weld beads to the flange so as to define the continuous weld between the connection and spaced weld beads.

7. A method as claimed in claim 6 wherein the PHS is an RHS or SHS, and one flange defines a tensile flange, such that the weld beads are transversely applied only across the tensile flange.

8. A method as claimed in claim 6 wherein the weld beads are applied in either a backward or forward bead deposit sequence; wherein in the forward bead deposit sequence one or more successive intermediate weld beads are applied to the flange, starting adjacent to the connection weld bead, to then progressively define the continuous weld, with the final weld bead then constituting the spaced weld bead; and wherein in the backward bead deposit sequence, before or after applying the connection weld bead, a spaced weld bead is applied, and one or more successive intermediate weld beads are then applied, starting from adjacent to the spaced weld bead and progressing until the connection weld bead is reached, thereby defining the continuous weld.

9. A method as claimed in claim 8, when used to connect an RHS or SHS to the member, wherein after forming a connection weld between the RHS/SHS and the member, the spaced weld bead is applied, and then two or more intermediate weld beads are applied in succession between the spaced weld bead and the connection weld, starting with the first intermediate weld bead adjacent to the spaced weld bead.

10. A method as claimed in claim 6 wherein an additional weld bead is applied in a region defined between the member, the connection weld and that intermediate weld bead immediately adjacent to the connection weld.

11. A method as claimed in claim 10 wherein the additional weld bead has a thickness that is at least 0.5 times the flange thickness.

12. A method as claimed in claim 6 wherein the connection weld is applied as one or more bead passes right around the peripheral end of the PHS to fully connect that end to the member.

13. A method as claimed in claim 6 wherein the combined weld beads have a width ranging from 10 to 30 mm.

14. A method as claimed in claim 6 wherein the weld beads each have a thickness that is in the range of 0.3 to 0.6 times the adjacent flange thickness.

15. A method as claimed in claim 1 wherein the member is another PHS, a supporting plate, a stiffening plate, a connecting plate, a base plate or a top plate.

16. A method as claimed in claim 1 wherein the PHS and the member define a joint about which a bending moment can be applied, as a result of a load applied to the PHS, or to the member, or both.

17. A method for increasing the rotation capacity in a welded moment connection between a PHS and a member comprising the step of forming a weld between the PHS and the member in a manner such that strain in corner(s) of the PHS, located at an end of the PHS that is weld connected to the member, is redistributed to an adjacent flange of the PHS.

18. A method for increasing the rotation capacity in a welded moment connection between a PHS and a member comprising the step of forming a weld between the PHS and the member in a manner that minimises the extent to which a heat effected zone through a flange of the PHS lies in a fracture zone adjacent to an internal end of the weld.

19. A method as defined in claim 1 that is applied to steel having reduced elongation at fracture when compared to a corresponding hot-formed steel section.

20. A method as claimed in claim 19 wherein the steel is cold-formed and is susceptible to fracture in a heat affected zone adjacent to where the PHS is joined to the member.
